(19) United States
(12) Patent Application Publication
(10) Pub. No.: US 2026/0176973 A1
(43) Pub. Date: Jun. 25, 2026

(54) PARTIALLY COATED TURBINE BLADE, ROTOR AND PRODUCTION METHOD

(71) Applicant: Siemens Energy Global GmbH & Co. KG, Munich, Bayern (DE)

(72) Inventors: James McCracken, York, SC (US); Thorsten Schüler, Essen (DE); Heinrich Stüer, Haltern (DE)

(73) Assignee: Siemens Energy Global GmbH & Co. KG, Munich, Bayern (DE)

(21) Appl. No.: 18/728,879

(22) PCT Filed: Dec. 27, 2022
(86) PCT No.: PCT/EP2022/087890

§ 371 Date: Jul. 14, 2024

(30) Foreign Application Priority Data
Jan. 24, 2022 (DE) 10 2022 200 711.5

(51) Int. Cl. F01D 5/14; F01D 5/20; F01D 5/22

(52) U.S. Cl. CPC F01D 5/141; F01D 5/147; F01D 5/20; F01D 5/225

(57) ABSTRACT

A partially coated turbine blade and a rotor produced and to be produced with such turbine blades is provided. The turbine blade includes a cover strip or support vane, which has a coating on its upper half, the coating extending at most up to 40% of the radial length of a vane blade of the turbine blade.

### CROSS REFERENCE TO RELATED APPLICATIONS

This application is the US National Stage of International Application No. PCT/EP 2022/087890 filed 27 Dec. 2022, and claims the benefit thereof, which is incorporated by reference herein in its entirety. The International Application claims the benefit of German Application No. DE 10 2022 200 711.5 filed 24 Jan. 2022.

### FIELD OF INVENTION

The invention relates to a partially coated turbine blade and to a rotor produced and to be produced with such turbine blades.

### BACKGROUND OF INVENTION

A problem in the operation of turbines with turbine blades are intrinsically generated vibrations (fluttering) at the tip of the turbine blade.

Up to now, the conventional strategy for suppressing fluttering was to modify the oscillation behavior of some blades in the disk by modifying e.g. their stiffness or damping properties.

EP 1 813 773 A2 discloses a bladed disk to which a coating is applied in different ways to balance the bladed disk at different locations.

US 2020/0032659 A1 discloses a rotor, the turbine blades of which comprise support fins. Fluttering occurs here, too.

### SUMMARY OF INVENTION

An object of the invention is therefore to solve the aforementioned problem.

The object is achieved by a turbine blade, a rotor and a process according to the claims.

The dependent claims specify further advantages, which can be combined with one another as desired to afford further advantages.

The description and the figures are only exemplary embodiments of the invention.

What is novel is the partial coating according to the invention for modifying the mass of blades that have a coupling, in particular of turbine blades with a shroud.

### BRIEF DESCRIPTION OF THE DRAWINGS

### In the Figures:

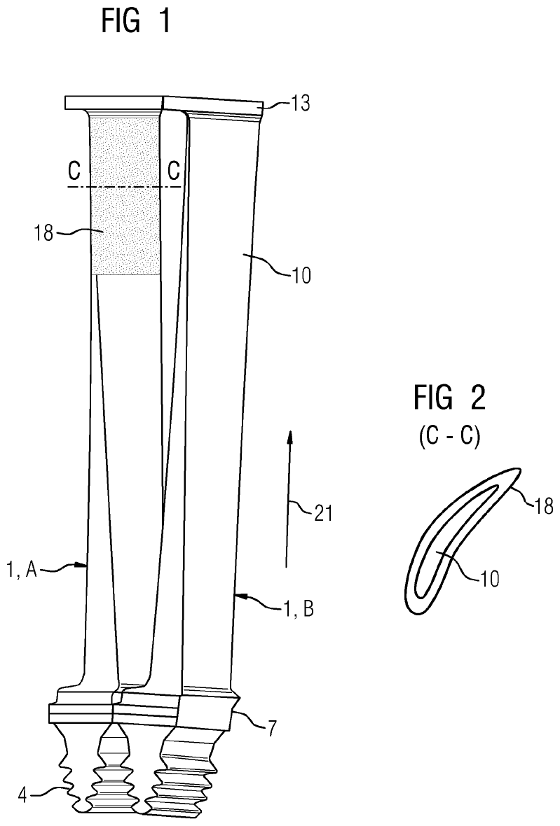

FIG. 1 shows a turbine blade according to the invention and part of a rotor according to the invention, and

FIG. 2 shows a cross section through a turbine blade according to the invention.

### DETAILED DESCRIPTION OF INVENTION

FIG. 1 depicts two types A, B of turbine blades 1, wherein one turbine blade A has an additional coating 18 and the other turbine blade B does not, this being the sole difference between them.

Otherwise, they have the same design or are produced in the same way.

The turbine blades are preferably for a gas turbine. However, the idea can be applied to all types of turbines, compressors or machines having blades.

A turbine blade 1, A, B has a blade root 4, which preferably has a fir tree structure.

Later on, the blade root 4 is inserted into a corresponding slot in a turbine disk or rotor disk, in order to form a rotor for a rotor stage.

A blade platform 7 adjoins the blade root 4 in the radial direction 21.

Beyond the blade platform 7, a blade airfoil 10 extends in the radial direction 21 to the radial end of the blade airfoil 10.

A shroud 13 is preferably present here at the end of the blade airfoil 10.

The shroud 13 is a coupling between adjacent turbine blades 1, A, B.

Support fins are another type of coupling, such turbine blades in particular not having a shroud.

Similarly, however, turbine blades having a shroud and support fins also exist.

Further types of coupling are conceivable for this invention.

The turbine blade according to the invention of type A has the coating 18 on the upper half of its blade airfoil 10, in particular at the radial end.

The coating 18 is preferably metallic.

The coating 18 constitutes a top coating.

A NiCoCrAIX coating is preferably used.

X preferably corresponds to yttrium (Y), rhenium (Re), tantalum (Ta) and/or silicon (Si).

It is preferably a NiCoCrAIY, NiCoCrAIYTa or NiCoCrAIYRe, NiCoCrAIYSi coating.

Otherwise, the turbine blades A, B in particular do not have any coatings on the blade airfoil 10.

However, the turbine blades of type A, B may also have a coating on the blade airfoil 10 outside the region for the coating 18, in particular all over the blade airfoil 10.

This can be a diffusion coating, which is to say for example an aluminide coating, preferably produced by alitizing.

In this case, the coating 18 is applied on top of the diffusion coating.

Similarly, the turbine blades A, B may also already have a top coating on the blade airfoil 10, in particular all over the blade airfoil 10.

If the turbine blades of type A, B already have a top coating on the blade airfoil, the turbine blades of type A are in that case made thicker only at the radial end by the coating 18, in particular by the same coating material as is used on the rest of the blade airfoil 10.

The coating 18 extends only at the radial end of the blade airfoil 10 and therefore has a maximum length of at most 40%, in particular up to at most 30%, of the length of the blade airfoil 10.

The coating 18 preferably extends right up to the shroud 13.

In particular, the coating 18 is present only on the blade airfoil, which is to say not also on the inner side of the shroud 13.

In the case of turbine blades with support fins, the coating 18 is present in particular up to the blade tip. If appropriate, the support fins except for their contact faces are covered by the coating 18.

The coating 18 preferably has a thickness of at least 0.01 mm and preferably up to at most 0.8 mm.

The Layer Thickness Is Preferably at Most 0.6 Mm.

The region from the coating 18 to the uncoated part, or thinner-coated part, of the blade airfoil 10 is preferably in the form of a tapering transition region, in order not to create any steps on the blade airfoil 10.

FIG. 2 depicts a section C-C through the turbine blade A with the coating 18.

The coating 18 is preferably a coating which goes all the way around the blade airfoil 10.

Variations on this are conceivable, such as only a coating on the suction side or pressure side of the turbine blade A.

A rotor has multiple stages: two, three or more.

The turbine blades of type A are preferably used for the third and/or fourth stage of the turbine or preferably for the last two stages.

A rotor having such a turbine blade of type A is formed as follows:
The natural frequencies are preferably measured by the ping test (ping frequencies of the blade on its own for the flutter-relevant mode) of the turbine blades 1 and sorted by the magnitude of the measured natural frequency.

The frequencies of the turbine blades 1 are measured individually and not in the installed state.

The influence on the natural frequency in the coupled/installed state is calculated beforehand.

Then, the sorting is divided into two groups, in particular of the same size, one group being formed with low natural frequencies and one group being formed with higher natural frequencies, with the result that the group with the lower natural frequencies always has a natural frequency which is lower than or equal to any natural frequency in the group with the higher natural frequencies.

The group of turbine blades with the lower natural frequencies receive the coating 18 according to the invention.

The rotor is assembled and therefore is not a bladed disk.

The turbine blades A, B are installed from the standpoints of minimization of the unbalance of the rotor and the maximum frequency differences of the turbine blades A and B.

In this case, preferably half of the turbine blades for a rotor disk/stage are turbine blades of type A and the other half is formed by turbine blades of type B.

A different distribution than in halves is also conceivable.

The coating 18 is preferably the same on all such turbine blades of type A, i.e. among other things has the same thickness or the same degree of thickening, the same extent, the same material.

After this, the blades are preferably installed in the corresponding slots in a rotor disk in a certain sequence, in particular in the sequence A-B-A-B etc. and thus form a stage in the form of part of a rotor.

Other sequences, such as A-A-B-A-A-B etc. or A-B-B-A-B-B etc. or A-A-B-B-etc. are also conceivable on account of a different selection as regards the natural frequencies.

1. A turbine blade (A) comprising:
a shroud or a supporting fin,
a blade airfoil, and
a coating on an upper half of the blade airfoil,
wherein the coating extends at most up to 40% of a radial length of the blade airfoil of the turbine blade (A).

2. The turbine blade as claimed in claim 1, wherein the coating is present only on the blade airfoil.

3. The turbine blade as claimed in claim 1,
wherein the coating extends to directly underneath the shroud, in particular extends only to directly underneath the shroud.

4. The turbine blade as claimed in claim 1,
wherein the coating of the turbine blade (A) with a support fin extends up to tip of the turbine blade.

5. The turbine blade as claimed in claim 1, wherein the coating comprises a NiCoCrAlX alloy,
wherein X is selected from the following group: yttrium (Y), rhenium (Re), tantalum (Ta), silicon (Si).

6. The turbine blade as claimed in claim 1,
wherein the coating has a layer thickness up to 0.8 mm, in particular up to 0.6 mm.

7. The turbine blade as claimed in claim 1,
wherein the coating extends around an entire periphery of the blade airfoil.

8. The turbine blade as claimed in claim 1,
wherein only the coating is present on the blade airfoil.

9. The turbine blade as claimed in claim 1,
where the coating on the blade airfoil is a thickening of a coating already present on the blade airfoil.

10. The turbine blade as claimed in claim 1,
wherein a region from the coating to an uncoated part or a thinner-coated part of the turbine blade (A) is in the form of a tapering transition region, in order not to create any steps on the blade airfoil.

11. A rotor, comprising:
at least two stages, in particular having at least three stages, very particularly having at least four stages,
wherein at least the last stage, in particular at least the last two stages, very particularly only the last two stages, have multiple turbine blades (A) with a coating as claimed in claim 1, and likewise turbine blades (B) without the coating,
wherein in particular half of the turbine blades of a stage are formed by coated or locally thickened turbine blades of type A and the other half are formed by uncoated or not locally thickened turbine blades of type B.

12. The rotor as claimed in claim 11,
wherein the turbine blades (A) coated or locally thickened by the coating and the turbine blades (B) are arranged in a disk of the rotor in a certain radial sequence,
in particular in the radial sequence comprises A-B-A-B etc.

13. A process for producing turbine blades (A) as claimed in claim 1, comprising:
measuring natural frequencies of turbine blades,
dividing the turbine blades into two groups comprising group (A) and group (B) wherein the group (A) is formed with low natural frequencies and the group (B) is formed with higher natural frequencies, wherein the group (A) with the lower natural frequencies then always has a natural frequency which is lower than or equal to any natural frequency in the group (B) with the higher natural frequencies, and
applying the coating to the group (A) with the lower natural frequencies.

14. The turbine blade (A) as claimed in claim 1,
wherein the coating is at a radial end of the blade airfoil.

15. The turbine blade (A) as claimed in claim 15,
wherein the coating is only at the radial end.

16. The turbine blade (A) as claimed in claim 1,
wherein the coating is made of metal.

17. The turbine blade (A) as claimed in claim 1,
wherein the coating extends at most up to 30% of the radial length of the blade airfoil of the turbine blade (A).

18. The process for producing turbine blades of claim 13,
wherein the group (A) and the group (B) are of the same size.
